(19) United States
(12) Patent Application Publication
(10) Pub. No.: US 2008/0186290 A1
(43) Pub. Date: Aug. 7, 2008

(54) APPARATUS AND METHOD TO ELIMINATE THE POWER-OFF IMAGE NOISE OF A FLAT PANEL DISPLAY

(75) Inventors: Po-Hsien Tsai, Sinshih Township (TW); Kun-Chih Lu, Sinshih Township (TW)

Correspondence Address: LOWE HAUPTMAN HAM & BERNER, LLP, 1700 DIAGONAL ROAD, SUITE 300, ALEXANDRIA, VA, 22314, US

(73) Assignee: HIMAX TECHNOLOGIES LIMITED, Sinshih Township (TW)

(21) Appl. No.: 11/671,596

(22) Filed: Feb. 6, 2007

(51) Int. Cl. G09G 5/00

(52) U.S. Cl. 345/204

(57) ABSTRACT

An apparatus to eliminate the power-off image noise of a flat panel display has a reset circuit and a switching device. The reset circuit asserts a switch signal when the flat panel display is turned off. The switching device decouples a source driver from several latch signals generated by a timing controller when the switch signal is asserted.

### BACKGROUND

1. Field of Invention

The present invention relates to a method and apparatus to eliminate the power-off image noise, and more particularly relates to the power-off image noise of a flat panel display.

2. Description of Related Art

The image-sticking problem is that the last image ‘sticks’ on the panel when the panel is turned off. FIG. 1 shows a conventional apparatus to eliminate the image-sticking problem. The flat panel display, especially the LCD panel display, includes a timing controller 120 transferring image data and latch signals, a gamma reference generator 180 providing a set of gamma reference voltages, a source driver latching the image data when the latch signals are asserted and converting them into analog voltages using the set of gamma reference voltages. The flat panel display further includes a reset circuit 150 generating an /XAO signal and cooperating with the gate driver 160, the timing controller 120, and the source driver 140.

FIG. 2 shows the signals used in the apparatus of FIG. 1. When the panel is turned off at time t1, the supply voltage VDD descends gradually. The reset circuit 150, source driver 140, and the timing controller 120 will operate normally only with a supply voltage respectively within the ranges 220, 230, and 240. Therefore, the signal 250 (/XAO signal) generated by the reset circuit 150 stays at a high logic level before time t2, but pulled low after time t2. The gate driver 160 discharges the channels of the flat panel display 170 when the signal 250 is pulled low, which eliminates the image-sticking problem.

However, the conventional apparatus induces another power-off image noise-band mura. In the duration t3, the timing controller 120 outputs the latch signal 260, whereby the image data are latched into the source driver 140 although the supply voltage has descended below its working range 230. This induces the power-off image noise.

### SUMMARY

According to one embodiment of the present invention, the apparatus has a reset circuit and a switching device. The reset circuit asserts a switch signal when the flat panel display is turned off. The switching device decouples a source driver from several latch signals generated by a timing controller when the switch signal is asserted.

According to another embodiment of the present invention, the method includes asserting a switch signal when the flat panel display is turned off, and decoupling a source driver from several latch signals generated by a timing controller when the switch signal is asserted.

According to another embodiment of the present invention, the apparatus has a reset circuit and a switching device. The reset circuit asserts a switch signal when the flat panel display is turned off. The switching device decouples a source driver from several gamma reference voltages provided by a gamma circuit when the switch signal is asserted.

According to another embodiment of the present invention, the method includes asserting a switch signal when the flat panel display is turned off, and decoupling a source driver from several gamma reference voltages provided by a gamma circuit when the switch signal is asserted.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 shows an apparatus to eliminate the image-sticking problem of the prior art;

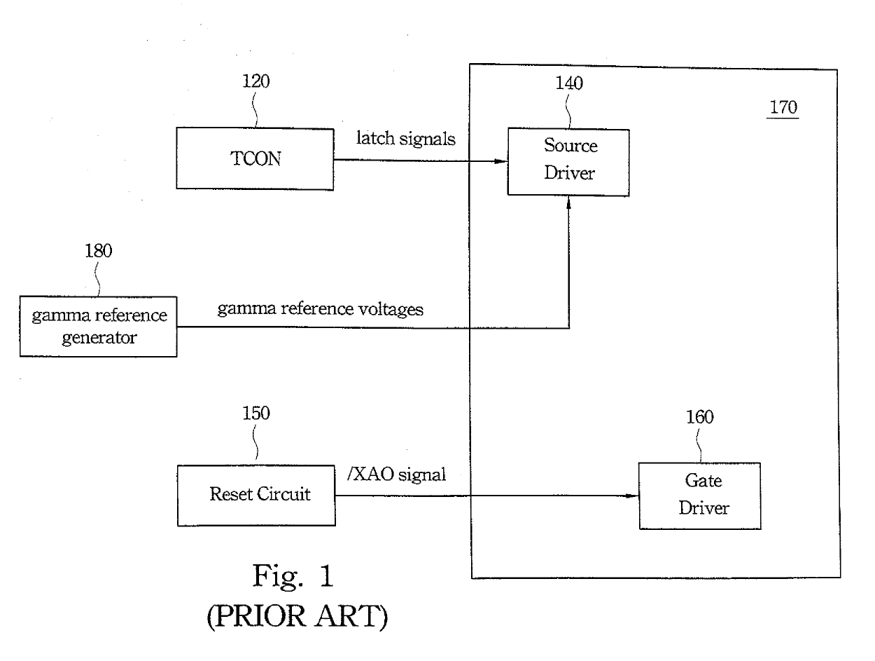

FIG. 2 shows the signals used in the apparatus of FIG. 1;

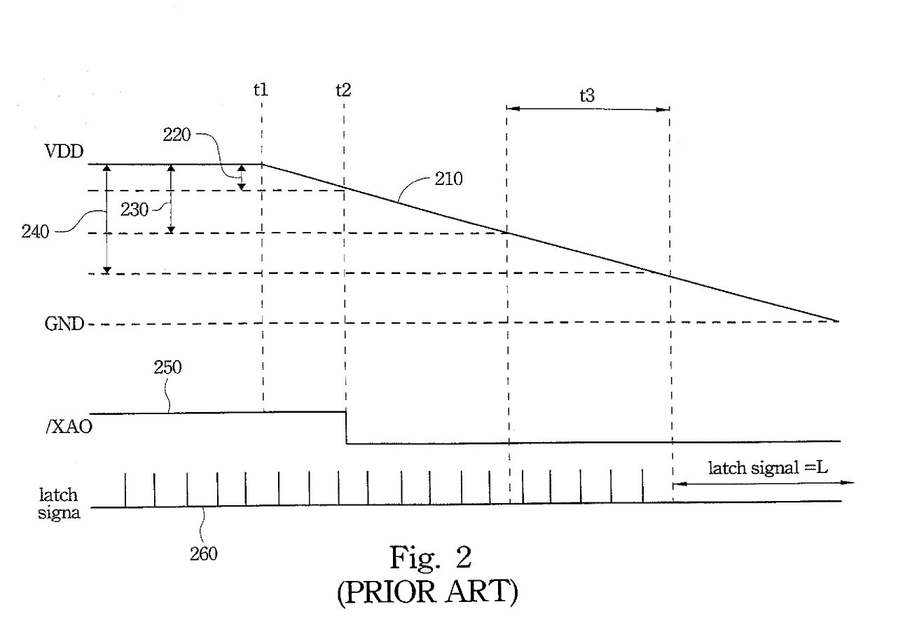

FIG. 3 shows the apparatus to eliminate the power-off image noise according to an embodiment of the invention; and

FIG. 4 shows the apparatus to eliminate the power-off image noise according to another embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

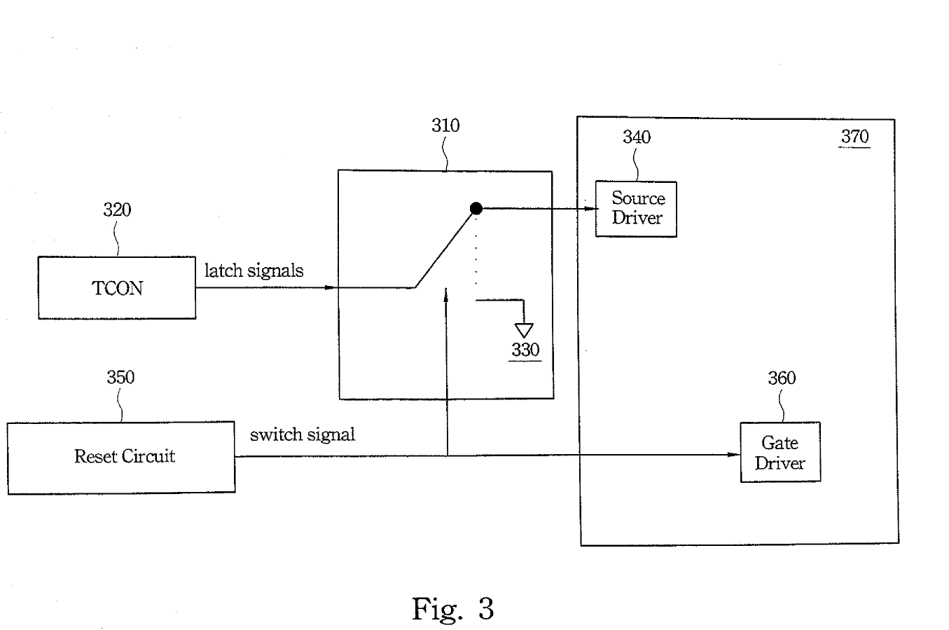

FIG. 3 shows the apparatus to eliminate the power-off image noise according to an embodiment of the invention. The apparatus for eliminating the power-off image noise of a flat panel display 370 has a reset circuit 350 and a switching device 310. The reset circuit 350 asserts a switch signal when the flat panel display 370 is turned off. The switching device 310 decouples a source driver 340 from several latch signals generated by a timing controller 320 when the switch signal is asserted.

The switching device 310 couples the source driver 340 to a ground end 330 when the switch signal is asserted. Thus, the switching device 310 prevents the latch signals from being input to the source driver 340 after the flat panel display 370 is turned off.

During the normal operation of the flat panel display 370, the switch signal is deasserted, and the switching device 310 couples the latch signals to the source driver 340. Therefore, the source driver 340 drives the flat panel display 370 with the latch signals generated by the timing controller 320.

Otherwise, when the switch signal is asserted, a gate driver 360 discharges several channels of the flat panel display 370 correspondingly. All the gate drivers can discharge all the channels of the flat panel display 370 to prevent the image-sticking problem. Since the switching device 310 couples the source driver 340 to a ground end 330 when the switch signal is asserted, the gate drivers can discharge all the channels more efficiently.

The switching device 310 can be configured in the timing controller 320 or in the source driver 340, or configured separately according to the requirement of the design.

Therefore, the present invention also offers a method to eliminate the power-off image noise of the flat panel display. The method includes asserting a switch signal when the flat panel display is turned off, and decoupling a source driver from several latch signals generated by a timing controller when the switch signal is asserted.

The method further includes coupling the source driver to a ground end, and discharging the channels of the flat panel display correspondingly when the switch signal is asserted. The method also includes coupling the latch signals to the source driver when the switch signal is deasserted.

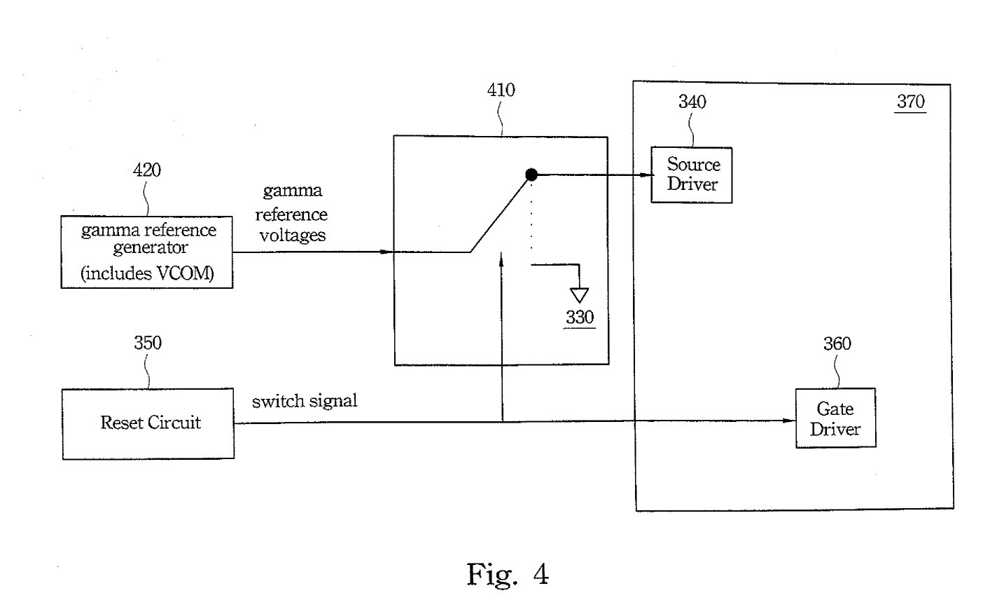

FIG. 4 shows the apparatus to eliminate the power-off image noise according to another embodiment of the invention. The apparatus for eliminating the power-off image noise of a flat panel display 370 has a reset circuit 350 and a switching device 410. The reset circuit 350 asserts a switch signal when the flat panel display 370 is turned off. The switching device 410 decouples a source driver 340 from several gamma reference voltages provided by a gamma reference generator 420 when the switch signal is asserted.

The switching device couples the source driver 340 to the ground end 330 when the switch signal is asserted. Thus, the switching device 310 prevents the gamma reference voltages from being input to the source driver 340 after the flat panel display 370 is turned off.

During the normal operation of the flat panel display 370, the switch signal is deasserted, and the switching device 410 couples the gamma reference voltages to the source driver 340. Therefore, the source driver 340 drives the flat panel display 370 using the gamma reference voltages generated by the gamma reference generator 420.

Otherwise, when the switch signal is asserted, a gate driver 360 discharges several channels of the flat panel display 370 correspondingly. All the gate drivers can discharge all the channels of the flat panel display 370 to prevent the image-sticking problem. Since the switching device 410 couples the source driver 340 to a ground end 330 when the switch signal is asserted, the gate drivers can discharge all the channels more efficiently.

Moreover, the switching device 410 couples a common voltage of the flat panel display 340 to the ground end 330 when the switch signal is asserted. Therefore, all the gamma reference voltages and the common voltage are the same, and the image-sticking problem is solved more efficiently thereby.

The switching device 410 can be configured in the source driver 340 or configured separately according to the requirement of the design.

Therefore, the embodiment of the present invention also offers a method to eliminate the power-off image noise of the flat panel display. The method includes asserting a switch signal when the flat panel display is turned off, and decoupling a source driver from several gamma reference voltages provided by a gamma reference generator when a switch signal is asserted.

The method further includes coupling the source driver and a common voltage of the flat panel display to a ground end, and discharging the channels of the flat panel display correspondingly when the switch signal is asserted. The method also includes coupling the gamma reference voltages to the source driver when the switch signal is deasserted.

In conclusion, the apparatus of the present invention includes a reset circuit and a switching device to prevent the signals from being inputted to the source driver, and discharges the channels more efficiently when the flat panel display is turned off, which eliminates the power-off image noise and the image-sticking problem.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus to eliminate the power-off image noise of a flat panel display having a timing controller transferring image data and latch signals, and a source driver latching the image data when the latch signals are asserted, the apparatus comprising:
a reset circuit asserting a switch signal when the flat panel display is turned off; and
a switching device decoupling the source driver from the latch signals when the switch signal is asserted.

2. The apparatus as claimed in claim 1, wherein the switching device couples the source driver to a ground end when the switch signal is asserted.

3. The apparatus as claimed in claim 1, wherein the switching device couples the latch signals to the source driver when the switch signal is deasserted.

4. The apparatus as claimed in claim 1, wherein a plurality of channels of the flat panel display are discharged by a gate driver correspondingly when the switch signal is asserted.

5. The apparatus as claimed in claim 1, wherein the switching device is configured in the timing controller.

6. The apparatus as claimed in claim 1, wherein the switching device is configured in the source driver.

7. A method to eliminate the power-off image noise of a flat panel display having a timing controller transferring image data and latch signals, and a source driver latching the image data when the latch signals are asserted, the method comprising the steps of:
asserting a switch signal when the flat panel display is turned off; and
decoupling the source driver from the latch signals when the switch signal is asserted.

8. The method as claimed in claim 7, further comprising a step of coupling the source driver to a ground end when the switch signal is asserted.

9. The method as claimed in claim 7, further comprising a step of coupling the latch signals to the source driver when the switch signal is deasserted.

10. The method as claimed in claim 7, further comprising a step of discharging a plurality of channels of the flat panel display correspondingly when the switch signal is asserted.

11. An apparatus to eliminate the power-off image noise of a flat panel display having a source driver converting image data into analog voltages using a set of gamma reference voltages, the apparatus comprising:
a reset circuit asserting a switch signal when the flat panel display is turned off; and
a switching device decoupling the source driver from the gamma reference voltages when the switch signal is asserted.

12. The apparatus as claimed in claim 11, wherein the switching device coupling the source driver to a ground end when the switch signal is asserted.

13. The apparatus as claimed in claim 11, wherein the switching device couples the gamma reference voltages to the source driver when the switch signal is deasserted.

14. The apparatus as claimed in claim 11, wherein a plurality of channels of the flat panel display are discharged by a gate driver correspondingly when the switch signal is asserted.

15. The apparatus as claimed in claim 11, wherein the switching device couples a common voltage of the flat panel display to the ground end when the switch signal is asserted.

16. The apparatus as claimed in claim 11, wherein the switching device is configured in the source driver.

17. A method to eliminate the power-off image noise of a flat panel display having a source driver converting image data into analog voltages using a set of gamma reference voltages, the method comprising the steps of:
asserting a switch signal when the flat panel display is turned off; and
decoupling the source driver from the gamma reference voltages when the switch signal is asserted.

18. The method as claimed in claim 17, further comprising the step of coupling the source driver to a ground end when the switch signal is asserted.

19. The method as claimed in claim 17, further comprising the step of discharging a plurality of channels of the flat panel display correspondingly when the switch signal is asserted.

20. The method as claimed in claim 17, further comprising the step of coupling a common voltage of the flat panel display to the ground end when the switch signal is asserted.
